(19) United States
(12) Patent Application Publication
(10) Pub. No.: US 2014/0154474 A1
(43) Pub. Date: Jun. 5, 2014

(54) HINGED FLOOR MAT

(71) Applicant: Edward S. Robbins, III, Muscle Shoals, AL (US)

(72) Inventor: Edward S. Robbins, III, Muscle Shoals, AL (US)

(21) Appl. No.: 14/068,397

(22) Filed: Oct. 31, 2013

Related U.S. Application Data
(60) Provisional application No. 61/733,711, filed on Dec. 5, 2012.

(51) Int. Cl. A47G 27/02; B29D 7/00

(52) U.S. Cl. CPC A47G 27/02; B29D 7/00
USPC 428/167; 264/151

(57) ABSTRACT

A one-piece, unitary floor mat may include a continuous plastic sheet including upper and lower surfaces, and an outer perimeter that joins the upper and lower surfaces. A plurality of grooves may be disposed along the upper surface. Each groove may include two sloped surfaces joined to one another at a trough in a substantially V-shaped configuration. A plurality of channels may be disposed along the lower surface. Each channel may be substantially aligned with a single corresponding groove, and each groove may be substantially aligned with a single corresponding channel. A plurality of substantially planar elongate panels may be defined by the grooves and the channels. An upper surface of each panel may be defined by two adjacent grooves. A lower surface of each panel may be defined by two adjacent channels. Successive panels may be movable relative one another to roll the floor mat into a rolled configuration.

### CROSS-REFERENCE TO RELATED APPLICATIONS

The present disclosure is related to and claims all benefit of U.S. Provisional Application Ser. No. 61/733,711 filed Dec. 5, 2012.

### BACKGROUND

The present disclosure relates to floor mats and, more particularly, to chair mats and floor runners for placement on a floor to protect an underlying floor covering such as carpet or hardwood. In particular, the present disclosure relates to a floor mat having features that enhance the ease of transport and handling and improve marketability.

Floor mats for office and home use are well known. Floor mats that are designed to be applied over carpeting typically are formed of a semi-rigid plastic. Often an underside surface of the floor mat has an array of short spikes or other protrusions that are intended to hold the mat firmly in place on the carpeting. While floor mats can be made without any spikes, such mats tend to move relative to the carpet in response to movement of a chair on the top surface of the mat. Thus a carpet-engaging structure is generally preferred to achieve satisfactory performance when the floor mat is applied over carpeting.

A typical floor mat is awkward to carry and/or otherwise handle due to its size, the semi-rigid nature of the material from which it is formed, and particularly due to the presence of the carpet-engaging features. Unless the floor mat is boxed or otherwise protected, the user typically carries the floor mat by gripping the mat about one or two of the edges of the floor mat, often resulting in irritation if not injury to the hands, due to the projecting elements from the underside of the floor mat. Commercial transport and storage of a typical floor mat also is problematic due to the same structural characteristics. The same characteristics also make the commercial display of large size floor mats awkward and uneconomical for many commercial settings at the retail level.

Attempts have been made to solve these problems by making the floor mat foldable to thereby reduce its size for handling purposes. See, for example, U.S. Pat. Nos. 4,448,625; 4,476,174; 4,784,888; 4,490,620; 5,073,428; 6,177,165; 6,183,833; 6,284,341; 6,284,341; and 6,737,150, each of which managed to reduce the size of the mat by half or more. Further, handles have been included as a portion of the floor mat to improve the ease and safety of handling of the mat. See, for example, U.S. Pat. Nos. 4,940,620; 6,177,165; 6,287,659 and 6,308,842. Generally, floor mats have been sold at office supply stores or distributors as opposed to retail stores, and to some extent, the handling problem was alleviated by boxing the floor mats individually or in groups prior to shipping. Floor mats are now being found increasingly in retail outlets, compounding the problem of safe handling. Thus, with increasing retail activity, new display schemes also are desired.

Even when supplied from a distributor in boxed form, the physical size and other attributes of the floor mat make its handling in a retail store environment problematic in part due to the sheer size of the mat, even when folded in half. Accordingly, there remains a need for a solution to the problem of transporting floor mats easily and safely from the point of manufacture through the point of stocking and display in a retail environment to the point of ultimate use.

Thus, there is a need for a floor mat that is collapsible (e.g., by rolling or folding) so as to occupy a relatively small portion of the total area covered by the mat in use. There is also a need for such a floor mat that is continuous within the perimeter of the mat so that it can easily be used to protect soft carpet surfaces, and that can include a carpet engaging structure which is designed for safe handling. It is desirable that these features be incorporated in a single structure having other features that contribute to easy handling and reduced cost.

### SUMMARY

The present disclosure provides for a new floor mat that may be easily rolled or folded for relatively simple transportation and storage.

In one example, a one-piece, unitary floor mat may include a continuous plastic sheet including an upper surface, a lower surface, and an outer perimeter that joins the upper surface and the lower surface. A plurality of grooves may be disposed along the upper surface. Each of the plurality of grooves may include two sloped surfaces joined to one another at a trough in a substantially V-shaped configuration. A plurality of channels may be disposed along the lower surface. Each channel may be substantially aligned with a single corresponding groove, and each groove may be substantially aligned with a single corresponding channel. A plurality of substantially planar elongate panels may be defined by the grooves and the channels. An upper surface of each panel may be defined by two adjacent grooves. A lower surface of each panel may be defined by two adjacent channels.

In another example, a one-piece, unitary floor mat may include a continuous plastic sheet including an upper surface, a lower surface, and an outer perimeter that joins the upper surface and the lower surface. The plastic sheet may include a plurality of grooves in the upper surface and a plurality of channels in the lower surface. Each channel may be positioned substantially opposite a single corresponding groove. Each groove may be positioned substantially opposite a single corresponding channel. A plurality of flexible segments may be cooperatively formed by the grooves and the channels. Each flexible segment may be disposed between one of the plurality of grooves and a corresponding one of the plurality of channels. Each flexible segment may have a thickness of between about 0.02 inches and about 0.035 inches. A plurality of substantially planar elongate panels may be defined by the flexible segments. Each panel may have a width of between about 1 inch and about 3 inches. Each flexible segment may be deformable in a first direction to move the lower surfaces of two adjacent panels angularly closer to one another and deformable in a second direction to move the upper surfaces of two adjacent panels angularly closer to one another.

In another example, a secondary surface covering can be applied to the upper surface and/or the lower surface of the unitary, one-piece floor mat. The secondary surface covering can be made of fabric, burlap, synthetic grass, carpeting or any other desirable material providing a decorative and/or a cushioning aspect to the floor mat.

In another example, a method of forming a floor mat may include extruding a plastic material into a nip region between a pair of rolls. The pair of rolls may include at least one pattern roll including a plurality of projections protruding radially outward from an outer surface of the pattern roll. The plurality of projections may extend longitudinally along the pattern roll and substantially parallel to one another. An extruded sheet may be extracted from the pair of rolls. The extruded sheet may include a plurality of channels formed in a lower surface of the extruded sheet. The plurality of channels may be reflective of the projections of the pattern roll. The extruded plastic sheet may be passed through a cooling unit. The floor mat may be cut from the extruded plastic sheet.

Other features of the present floor mat and the corresponding advantages of those features will be come apparent from the following discussion of a preferred embodiment of the present invention, exemplifying the best mode of practicing the present invention, which is illustrated in the accompanying drawings. The components in the figures are not necessarily to scale, emphasis instead being placed upon illustrating the principles of the invention. Moreover, in the figures, like referenced numerals designate corresponding parts throughout the different views.

### BRIEF DESCRIPTION OF THE DRAWINGS

FIG. 1 illustrates a perspective view of one example of a floor mat.

FIG. 2 illustrates a side view of the floor mat shown in FIG. 1.

FIG. 3 illustrates a side view of one example of a floor mat with engaging members.

FIG. 4 illustrates the arrangement of the engaging members of the floor mat shown in FIG. 3.

FIG. 5 illustrates a side view of one example of a floor mat with engaging members.

FIG. 6 illustrates the arrangement of the engaging members of the floor mat shown in FIG. 5.

FIG. 7 illustrates one example of a floor mat partially in a rolled configuration.

FIG. 8 illustrates one example of an apparatus for forming a floor mat.

FIG. 9 illustrates one example of a pattern roll of the apparatus shown in FIG. 8.

FIG. 10 illustrates an end view of the pattern roll shown in FIG. 9.

FIG. 11 illustrates one example of an apparatus for forming a floor mat.

FIG. 12 illustrates one example of an apparatus for forming a floor mat.

### DESCRIPTION OF PREFERRED EMBODIMENTS

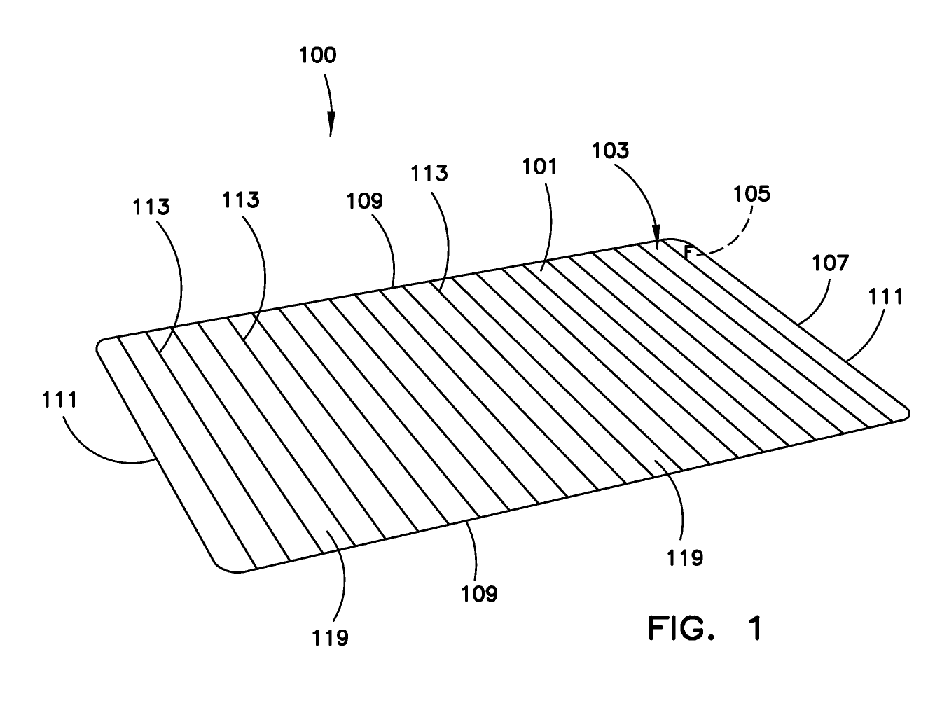

FIG. 1 illustrates one example of a floor mat 100. In one example, the floor mat 100 may be a chairmat (e.g., for placement at a desk or a table). The chairmat may serve as the principal contact area for a chair, which may be fitted with rollers or casters. The chairmat may help to protect the floor surface underlying the chairmat from damage which otherwise may be caused by the chair rolling and/or sliding on the floor surface. In one example, the floor mat 100 may be a floor runner. The floor runner may be placed over a floor surface to protect the underlying floor surface from damage. For example, the floor runner may be placed over the floor surface of a hallway to protect the floor surface from relatively high traffic passing through the hallway. Additionally, or alternatively, the floor runner may be placed over an outdoor surface (e.g., grass) to protect the outdoor surface and/or to provide a substantially stable and/or smooth traffic surface (e.g., for foot traffic). The floor mat 100 may be used in any suitable location to protect an underlying surface and/or to provide a substantially smooth usable surface.

The floor mat 100 may be configured as a unitary, one-piece structure including a plastic sheet 101. The plastic sheet 101 may be formed from any suitable polymeric material known in the art. Preferably, the plastic sheet 101 may be formed from a semi-rigid plastic material. In one example, the plastic sheet 101 may include polyvinylchloride (PVC). In other examples, the plastic sheet 101 may include polycarbonate, acrylic, polypropylene, polyester, ethylene vinyl acetate, thermoplastic polyurethane, olefinic elastomer, thermoplastic rubber, thermoplastic vulcanizate, or any other suitable material. The plastic sheet 101 may have an upper surface 103, a lower surface 105, and an outer perimeter 107 joining the upper surface and the lower surface to one another. The upper surface 103 and/or the lower surface 105 may be continuous. In other words, the plastic sheet 101 may be continuous such that the floor mat 100 is substantially free of cuts or other discontinuities extending through the entire width of the plastic sheet. The outer perimeter 107 may include a plurality of edges. For example, the floor mat 100 may have a substantially rectangular shape as shown in FIG. 1, and the outer perimeter 107 may include a pair of longitudinal edges 109 joined to one another by a pair of transverse edges 111. The longitudinal edges 109 may be substantially parallel to one another. Additionally, or alternatively, the transverse edges 111 may be substantially parallel to one another. In other examples, the floor mat may have any other suitable shape (e.g., circular, elliptical, triangular, or any other polygonal or non-polygonal shape). In some examples, the floor mat may include an integral extension protruding from one edge thereof. The extension may be configured to project into the well area of a desk in a conventional manner.

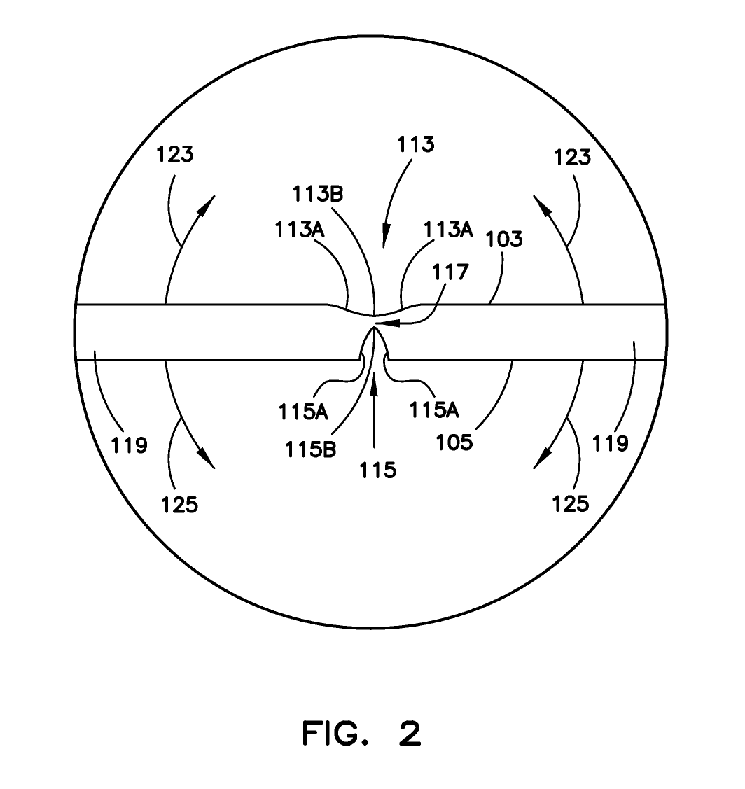

The floor mat 101 may include one or more grooves 113 in the upper surface 103 and/or one or more channels 115 in the lower surface 105. FIG. 2 illustrates a partial side view of a longitudinal edge 109 of the floor mat 100 shown in FIG. 1. In one example, the floor mat 100 may include a plurality of grooves 113 in the upper surface 103 and a plurality of channels 115 in the lower surface 105 as shown in FIGS. 1-2. The grooves 113 may be disposed along the upper surface 103. For example, the grooves 113 may extend along the upper surface 103 between opposite longitudinal edges 109 of the perimeter 107 (e.g., in a transverse direction) as shown in FIG. 1. Additionally, or alternatively, the grooves 113 may be substantially parallel to one another. The grooves 113 may be spaced from one another to form a plurality of panels therebetween as further described below. The channels 115 may be disposed along the lower surface 105. For example, the channels 115 may extend along the lower surface 105 between opposite longitudinal edges 109 of the perimeter 107 (e.g., in a transverse direction) as shown in FIG. 2. Additionally, or alternatively, the channels 115 may be substantially parallel to one another. The channels 115 may be spaced from one another to form a plurality of panels therebetween as further described below.

In other examples, the grooves and/or the channels may extend in any other direction along the respective upper surface and lower surface of the floor mat. For example, the grooves and/or the channels may extend between opposite transverse edges (e.g., in a longitudinal direction), between a longitudinal edge and a transverse edge (e.g., in an oblique direction), or in any other direction.

Each groove 113 may be aligned with a corresponding channel 115 as shown in FIG. 2. In other words, each channel 115 may be positioned substantially opposite a corresponding groove 113. Each groove 113 may be aligned with a single channel 115 and/or each channel may be aligned with a single groove. To that end, the number of grooves 113 may be equal to the number of channels 115. The plastic sheet 101 of the floor mat 100 may include a plurality of webs 117 disposed between the grooves 113 and the channels 115. For example, a web 117 may be disposed between each groove 113 and the corresponding channel 115 as shown in FIG. 2. Each web 117 may be configured as a relatively thin portion of the plastic sheet 101 defined between a groove 113 and a channel 115. The web 117 may include a portion of the plastic sheet 101 remaining intact after formation of the grooves 113 and the channels 115 in the respective upper surface 103 and lower surface 105 as further described below. The web 117 may be sufficiently flexible to enable bending and/or rolling of the floor mat 100 also as further described below. To that end, the webs 117 may be configured as flexible segments or hinges cooperatively formed by the grooves 113 and the channels 115.

The floor mat 100 may include a plurality of panels 119 as shown in FIGS. 1-2. The panels 119 may be configured as substantially planar elongate members defined by the grooves 113 and the channels 115. For example, each panel 119 may be disposed between two adjacent grooves 113 and two adjacent channels 115. Each panel 119 may include an upper surface defined by two adjacent grooves 113 and a lower surface defined by two adjacent channels 115. The panels 119 may be defined by the webs 117 disposed between the grooves 113 and the channels 115. Adjacent panels 119 may be joined to one another by the web 117 disposed between the adjacent panels. In this manner, the unitary plastic sheet 101 may be cooperatively formed by the panels 119 and the webs 117 disposed between the panels. The floor mat 100 may be flexible about the webs 117 to move adjacent panels 119 relative to one another to roll and/or fold the floor mat as further described below.

Each groove 113 may include two sloped surfaces 113A joined to one another at a trough 113B. In one example, the groove 113 may have a substantially V-shaped configuration collectively formed by the sloped surfaces 113A and the trough 113B as shown in FIG. 2. In other words, the sloped surfaces 113A may extend away from the trough 113B in opposite longitudinal directions and outward away from the middle portion of the plastic sheet 101 to form the groove 113 having a substantially V-shaped cross section. The sloped surfaces 113A may be substantially planar as shown in FIG. 2. Alternatively, the sloped surfaces 113A may be curved (e.g., in a convex or a concave orientation). Each of the sloped surfaces 113A may extend between the upper surface of a respective panel and the trough 113B such that the groove 113 extends from the upper surface 103 inward toward the middle portion of the plastic sheet 101. The grooves may be sized and shaped such that the upper surface 103 of the floor mat 100 is relatively smooth. This may enable a chair to roll and/or slide easily along the upper surface 103 of the floor mat 100. Additionally, or alternatively, this may provide a relatively smooth walking surface (e.g., without sharp angles that may present a tripping hazard).

Each channel 115 may include two side walls 115A joined to one another at an apex 115B. In one example, the apex 115B may have a substantially U-shaped configuration as shown in FIG. 2. In other words, the apex 115B may have a substantially U-shaped cross section. The side walls 115A may be substantially planar also as shown in FIG. 2. Alternatively, the side walls 115A may be curved (e.g., in a convex or a concave orientation). The side walls 115A may be angled relative to one another (e.g., may be non-parallel). For example, the side walls 115A may extend away from the apex 115B in opposite longitudinal directions and outward away from the middle portion of the plastic sheet 101. Each of the side walls 115A may extend between the lower surface of a respective panel and the apex 115B such that the channel 115 extends from the lower surface 105 inward toward the middle portion of the plastic sheet 101.

The floor mat 100 and/or the various components thereof may be sized and/or shaped to enable rolling and/or folding of the floor mat as further described below. The dimensions described herein are exemplary, and the floor mat 100 may have any other suitable dimensions. In one example, the grooves 113 may have a depth of less than about 0.01 inches, typically between about 0.001 inches and about 0.008 inches. The depth of a groove 113 may indicate the distance between the upper surface 103 of the plastic sheet 101 and the trough 1138 of the groove at an approximate longitudinal center of the groove. In other words, the depth of a groove 113 may indicate the distance by which the groove extends into the upper surface 103 of the plastic sheet 101.

In one example, the channels 115 may have a width of between about 0.04 inches and about 0.06 inches. The width of a channel 115 may indicate the distance between the side walls 115A of the channel along the lower surface 105 of the plastic sheet. Additionally, or alternatively, the channels 115 may have a depth of between about 0.06 inches and about 0.08 inches, preferably about 0.07 inches. The depth of a channel 115 may indicate the distance between the lower surface 105 of the plastic sheet 101 and the apex 115B of the channel at an approximate center of the apex. In other words, the depth of a channel 115 may indicate the distance by which the channel extends into the lower surface 105 of the plastic sheet 101.

In one example, the webs 117 between corresponding grooves 113 and channels 115 may have a thickness of between about 0.02 inches and about 0.035 inches, typically between about 0.022 inches and about 0.028 inches. The thickness of a web 117 may indicate the distance between the groove 113 (e.g., the trough 113B) and the channel 115 (e.g., the apex 115B) that cooperatively define the web. In other words, the thickness of the web may indicate the thickness of the plastic sheet 101 remaining along the web 117 after formation of the groove 113 in the upper surface 103 and the channel 115 in the lower surface 105.

In one example, the panels 119 may have a width of between about 1 inch and about 3 inches, preferably about 2 inches. The width of a panel 119 may indicate the distance between the two webs 117 on opposing sides of the panel. The diameter of the floor mat 100 in the rolled configuration, as further described below, may depend on the width of the panels 119. For example, reducing the width of the panels may enable reduction of the diameter of the floor mat 100 in the rolled configuration (e.g., because the floor mat may be rolled into a tighter roll). Alternatively, increasing the width of the panels may enable the diameter of the floor mat 100 in the rolled configuration to be increased (e.g., because the floor mat may be rolled into a looser roll). Additionally, or alternatively, the panels 119 may have a thickness of between about 0.09 inches and about 0.105 inches, preferably about 0.098 inches. The thickness of a panel 119 may indicate the distance between the upper surface 103 and the lower surface 105 of the plastic sheet 101 along the panel 119.

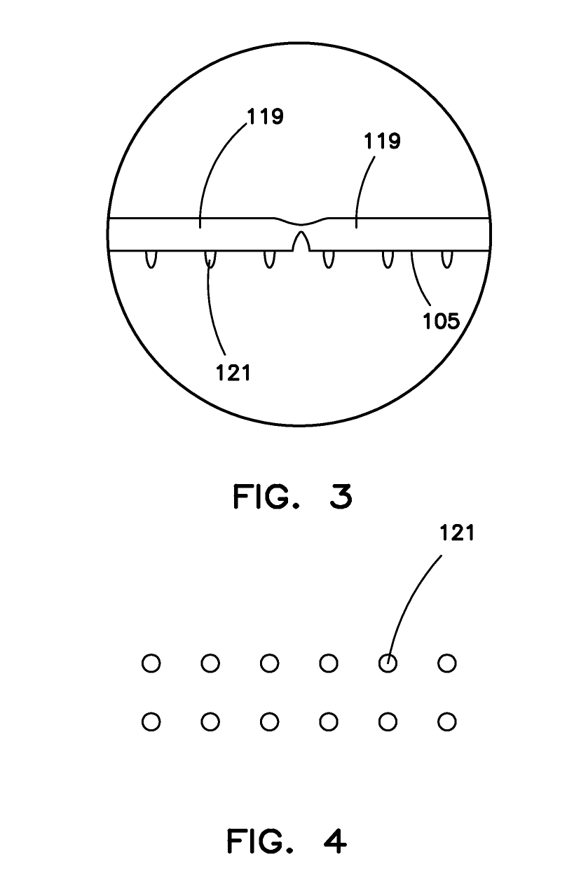

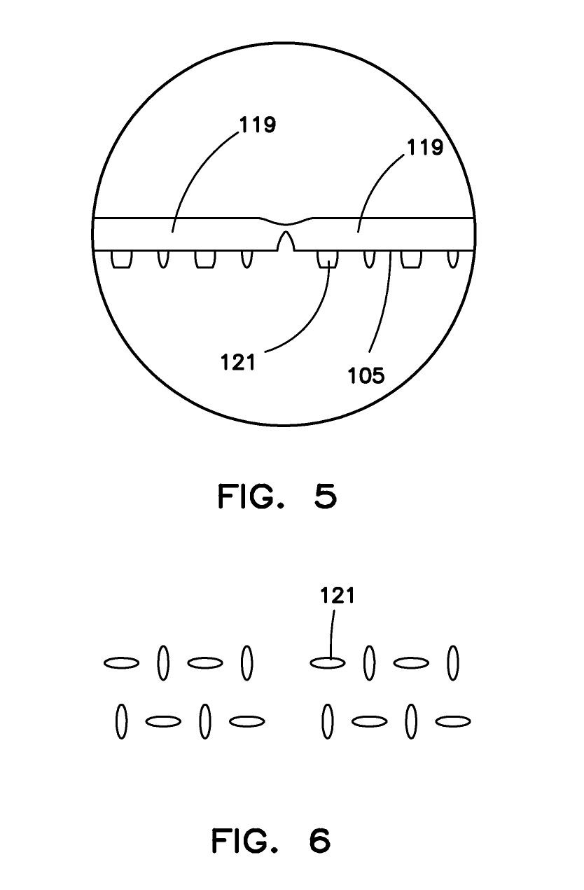

The floor mat 110 may be configured for placement on a relatively soft and/or flexible underlying surface (e.g., carpet or grass). To that end, the floor mat 110 may include a plurality of engaging members extending from the lower surface 105 to engage the underlying surface. For example, FIGS. 3 and 5 illustrate partial side views of longitudinal edges 109 of respective examples of the floor mat 100 including a plurality of engaging members 121. In the example shown in FIG. 3, the engaging members 121 may be configured as pin cleats. The pin cleats may be configured as relatively sharp spikes extending outward from the lower surface 105. FIG. 4 illustrates the lower surface 105 of the floor mat 100 shown in FIG. 3. The pin cleats may be arranged in a grid or array on the lower surface 105 as shown in FIG. 4. In the example shown in FIG. 5, the engaging members 121 may be configured as anchorbar cleats. The anchorbar cleats may be configured as elongate wedge-shaped members extending outward from the lower surface 105. FIG. 6 illustrates the lower surface 105 of the floor mat 100 shown in FIG. 5. The anchorbar cleats may be arranged in a grid or array on the lower surface 105. Each anchorbar cleat may be arranged in a perpendicular orientation relative to the adjacent anchorbar cleats within the grid as shown in FIG. 4. In other examples, the engaging members 121 may have any other suitable configuration known in the art. Additionally, or alternatively, the engaging members 121 may be arranged on the lower surface 105 of the floor mat 100 in any suitable manner. The engaging members may be disposed along substantially the entire lower surface 105 or along any portion of the lower surface (e.g., at one or more corners of the floor mat 100).

In other examples, the floor mat 100 may be configured for placement on a relatively hard and/or smooth underlying surface (e.g., hardwood, laminate, tile, or concrete). To that end, the lower surface 105 may be substantially smooth as shown in FIG. 2. In other words, the engaging members 121 may be omitted. In other examples, a secondary surface covering can be applied to the upper surface of the unitary, one-piece floor mat. The secondary surface covering can be made of fabric, burlap, synthetic grass, carpeting or any other desirable material providing a decorative and/or a cushioning aspect to the floor mat.

The configuration of the grooves 113, the channels 115, the webs 117, and the panels 119 may enable rolling and/or folding of the floor mat 100. The webs 117 may serve as a plurality of flexible segments or hinges disposed between the panels 119 of the floor mat 100. The two panels 119 adjacent to a web 117 may be movable relative to one another (e.g., by flexing or bending the web). The thickness of the web may be selected to enable flexing of the web 117 while retaining sufficient strength to avoid breakage of the web, which may result in separation of the panels from one another. In other words, the web 117 may be sufficiently thin that the floor mat 100 may be folded or bent at the web as further described below, yet sufficiently thick that the web will not break upon such folding or bending.

The two panels 119 adjacent to a web 117 may be movable about the web such that the upper surfaces of the panels are brought closer to one another. In other words, the floor mat 110 may be rollable and/or foldable in an upward direction such that the two panels 119 move angularly about an axis of the web, and the upper surfaces of the panels move toward one another as shown by the arrows 123 of FIG. 2. Additionally, or alternatively, the two panels 119 adjacent to the web 117 may be movable about the web such that the lower surfaces of the panels are brought closer to one another. In other words, the floor mat 110 may be rollable and/or foldable in a downward direction such that the two panels 119 move angularly about an axis of the web, and the lower surfaces of the panels move toward one another as shown by the arrows 125 of FIG. 2. In one example, the floor mat 100 may be rollable and/or foldable in both the upward direction and the downward direction. In other words, the configuration of the floor mat 100 may enable rolling and/or folding of the floor mat in both the upward direction and the downward direction

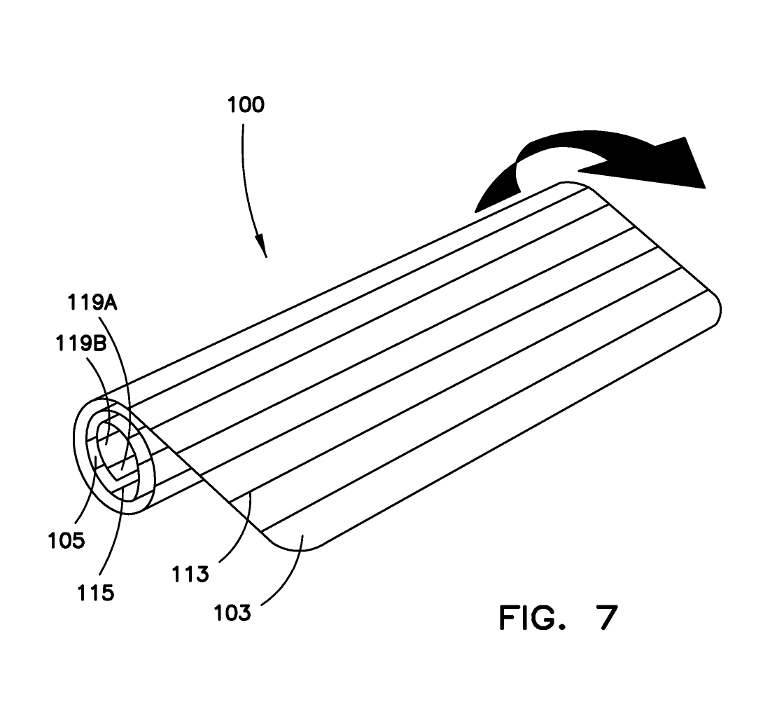

In one example, the plurality of grooves 113 and the plurality of channels 115 may be distributed along a length of the plastic sheet 101 as shown in FIG. 1. The plastic sheet 101 may be formed by an alternating series of panels 119 and webs 117 disposed between adjacent panels. Successive panels 119 may be moved relative to one another to roll the floor mat 100 into a rolled configuration. FIG. 7 illustrates the floor mat 100, a segment of which is in the rolled configuration. Starting at an end of the plastic sheet 101, a first panel 119A and a second panel 119B may be moved angularly toward one another as described above. For example, the upper surface of each of the first panel 119A and the second panel 119B may be moved toward one another. Alternatively, the lower surface of each of the first panel 119A and the second panel 119B may be moved toward one another. This may cause the web 117 between the first panel 119A and the second panel 119B to flex or bend as described above. Upon such movement, the first panel 119A and/or the second panel 119B may remain substantially planar. Alternatively, upon such movement, the first panel 119A and/or the second panel 119B may curve (e.g., in the direction of the movement). Successive panels 119 along the length of the plastic sheet 101 may be moved relative to one another in a similar manner to roll the floor mat 100 as shown in FIG. 7. In the rolled configuration, a portion of the upper surface 103 may be in contact with a portion of the lower surface 105. In other words, the upper surface of at least one panel may be in contact with a lower surface of at least one other panel.

In the rolled configuration, the floor mat 100 may have a substantially cylindrical shape, which may occupy a significantly smaller area than the floor mat in the unrolled configuration. In this manner, rolling the floor mat 100 may simplify the storage and/or transportation of the floor mat. For example, the rolled floor mat 100 may be easier to handle than the larger, substantially planar floor mat. Additionally, or alternatively, the rolled floor mat 100 may be placed into a box or a tube and/or maintained in the rolled configuration using a retaining member (e.g., tape, adhesive, band, or tie) for storage and/or transportation.

The plurality of grooves 113 and the plurality of channels 115 may be distributed along the length of the plastic sheet 101 as described above. In this manner, the floor mat 110 may be configured to be rolled lengthwise as shown in FIG. 7. In other examples, the plurality of grooves and the plurality of channels maybe distributed along the width of the plastic sheet (e.g., to enable the floor mat to be rolled widthwise) or at any other angle along the plastic sheet. The floor mat may be configured such that the shorter dimension of the floor mat (e.g., the width of the floor mat 100 shown in FIG. 1) may be the length of the substantially cylindrical rolled floor mat. The diameter of the substantially cylindrical rolled floor mat may be determined by the longer dimension of the floor mat (e.g., the length of the floor mat 100 shown in FIG. 1). Rolling the floor mat about itself along the longer dimension may enable a substantial reduction of the area occupied by the rolled floor mat relative to the unrolled floor mat (e.g., by rolling the longer dimension up into the diameter of the rolled floor mat). In other examples, the floor mat may be rolled along the shorter dimension or along any other dimension.

The webs 117 may be foldable in either direction such that the floor mat 100 may be rolled in an upward direction or a downward direction as described above. Additionally, or alternatively, alternating webs 117 may be folded in opposite directions. For example, a web 117 on one side of a panel 119 may be folded in the upward direction, and an adjacent web on an opposite side of the same panel may be folded in the downward direction. In this manner, the floor mat 100 may be folded like an accordion, with each web folded in an opposite direction as compared to the two adjacent webs.

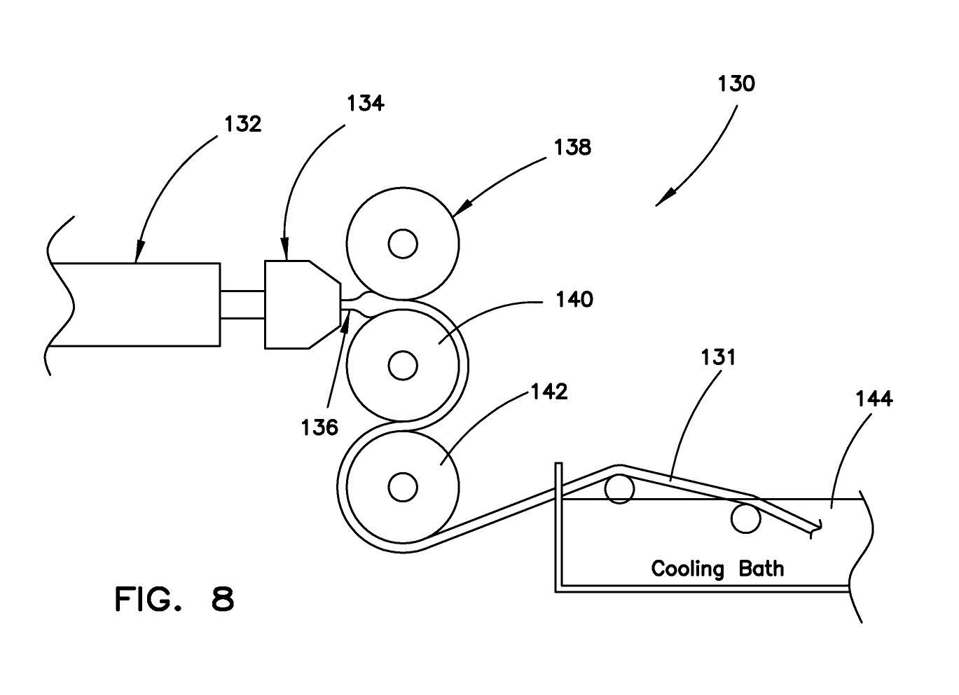

FIG. 8 illustrates one example of an apparatus 130 that may be used to form a continuous extruded sheet 131 of plastic that may be used for the floor mat 100 described herein. The apparatus may include an extruder 132. The extruder 132 may feed molten plastic material to a die 134. Extrudate in a molten form may exit the die 134 and enter a nip region 136 between a pair of rolls 138 and 140. At least one of the rolls 138 and 140 may have surface features configured to be impressed into the surface or surfaces of the extruded sheet 131 as further described below. In other words, at least one of the rolls 138 and 140 may be configured as a pattern roll. A take off roll 142 may transfer the extruded sheet 131 from the forming operation into a cooling unit such as a cooling bath 144 in which the extruded sheet may be cooled.

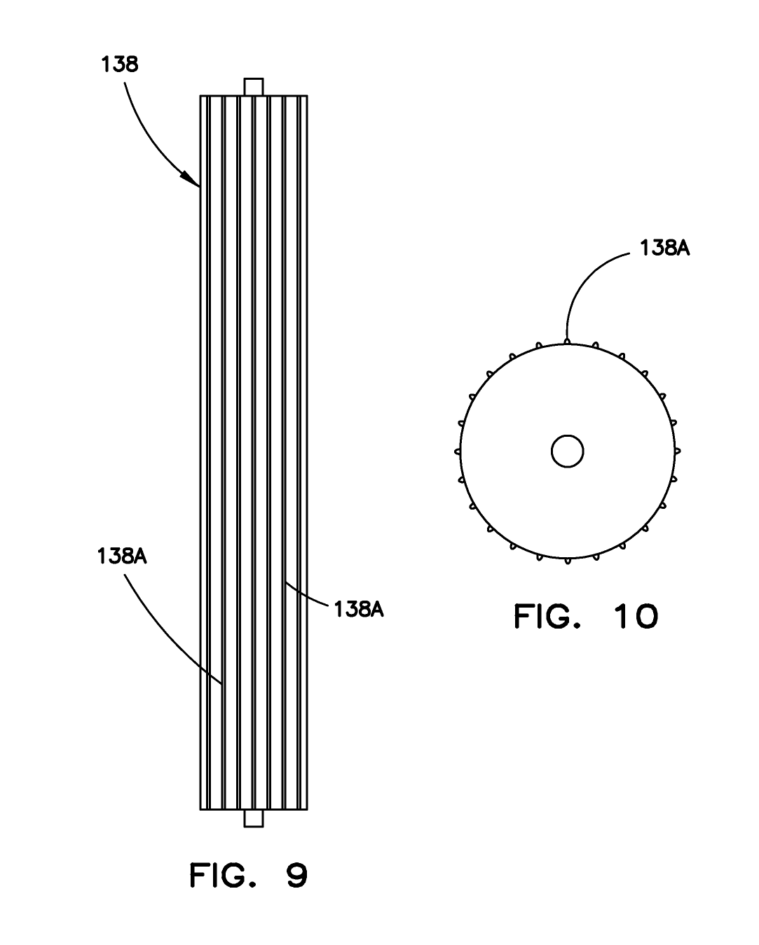

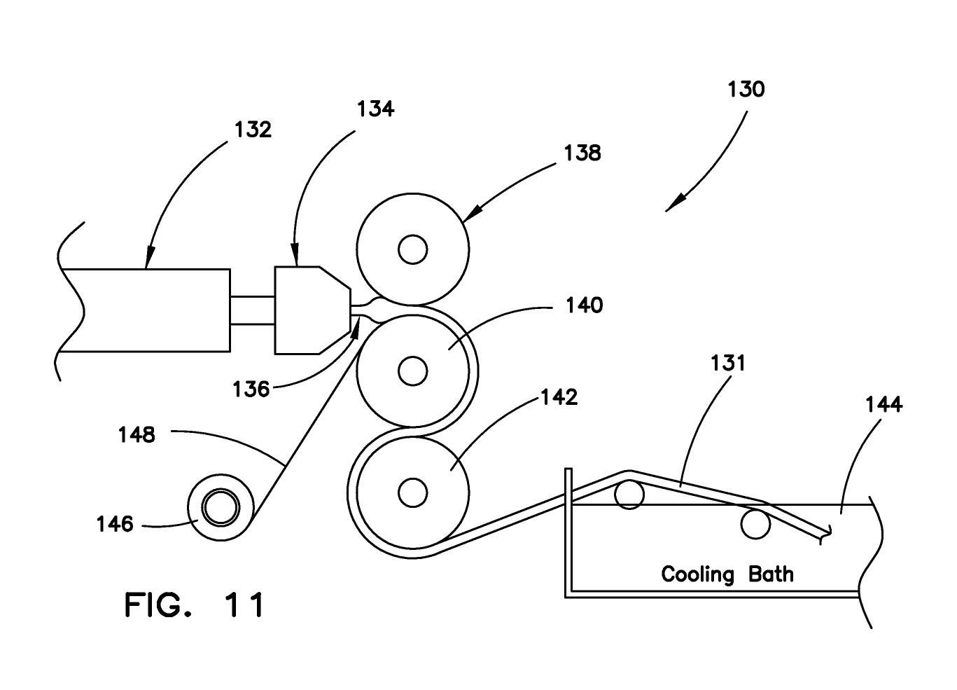

In one example, the roll 138 may be configured as a pattern roll. FIG. 9 illustrates one example of the pattern roll 138, and FIG. 10 illustrates an end view of the pattern roll of FIG. 9. The pattern roll 138 may have a substantially cylindrical shape. However, the pattern roll 138 may include one or more projections 138 extending radially outward. For example, the pattern roll 138 may include a plurality of projections disposed circumferentially about the outer surface thereof as shown in FIGS. 9-10. The projections 138A may be configured to form a plurality of channels in the extruded sheet 131. The channels formed in the extruded sheet 131 may correspond to the channels 115 in the lower surface of the plastic sheet 101. To that end, each projection 138A may have a size and shape corresponding to the size and shape of the channels 115 as described above with reference to FIG. 2. The projections 138A may be configured as a series of paddles extending longitudinally along the pattern roll 138A and spaced from one another circumferentially about the pattern roll as shown in FIGS. 9-10. The spacing between the projections 138A may correspond to the widths of the panels 119 of the plastic sheet 101.

Forming the projections 138A longitudinally across the pattern roll 138 may enable production of a plastic sheet 101 having any number of panels 119. For example, any amount of plastic material may be passed through the nip region 136 to form an extruded sheet 131 having any desired length. The distance between adjacent channels formed in the extruded sheet 131 may be determined by the distance between adjacent projections 138A on the pattern roll 138. Thus, the number of channels formed in the extruded sheet 131 may be adjusted by adjusting the length of the extruded sheet. In other words, a longer extruded sheet 131 having more channels may be formed by passing more plastic material through the nip region 136, and a shorter extruded sheet having fewer channels may be formed by passing less plastic material through the nip region. In this manner, the length of the extruded sheet 131 and thus, the number of channels formed therein may be adjusted without modifying and/or replacing the pattern roll 138 (i.e., without retooling). The extruded sheet 131 may be cut to form a plastic sheet 101 having any number of panels 119 (e.g., to achieve a desired length).

The portions of the outer surface of the pattern roll 138 positioned circumferentially between the projections may be substantially smooth. Alternatively, the portions of the outer surface of the pattern roll 138 positioned circumferentially between the projections may be textured. The textured portions may include raised and/or lowered portions that may impart corresponding lowered and/or raised portions to the plastic sheet 131. For example, the textured portions of the pattern roll 138 may include lowered portions sized and shaped to correspond to the engaging members 121 on the lower surface 105 of the plastic sheet. Additionally, or alternatively, the textured portions may include raised and/or lowered portions to form a roughened texture on the extruded sheet 131. A corresponding roughened texture on the lower surface 105 of the plastic sheet 101 may help to retain the floor mat 100 in place (e.g., by increasing the friction between the floor mat and the underlying surface).

The outer surface of the roll 140 may be substantially smooth. Alternatively, the outer surface of the roll 140 may be textured as described above with reference to the pattern roll 138. The textured outer surface may form a texture on the extruded sheet 131, which may correspond to a texture on the upper surface 103 of the plastic sheet 101. Such a textured upper surface 103 may help to improve traction on the upper surface (e.g., for foot traffic on the floor mat 100).

In one example, the outer surface of the roll 140 is free of a projection corresponding to the grooves 113 in the upper surface 103 of the plastic sheet 101. In other words, the extruded sheet 131 may not include grooves corresponding to the grooves 113 as the extruded sheet initially exits the nip region 136 between the rolls 138 and 140.

Upon exiting the nip region 136, the extruded sheet 131 may include a plurality of thinned regions adjacent to the channels formed by the pattern roll 138 (e.g., between the channels and the upper surface of the extruded sheet). Upon cooling in the cooling bath 144, the thinned regions may contract to a greater degree than the remainder of the extruded sheet 131. Such contraction of the thinned regions may cause grooves to be formed in extruded sheet 131 opposite the channels. The grooves formed in the extruded sheet 131 may correspond to the grooves 113 in the upper surface 103 of the plastic sheet 101. The amount of contraction of the thinned regions may be controlled to adjust the depth and/or width of the grooves 113 and/or the thickness of the webs 117. The amount of contraction may be controlled, for example, by controlling the temperature of the cooling bath 144. Reducing the temperature of the cooling bath 144 may increase the amount of contraction, which may increase the depth of the grooves 113 and decrease the thickness of the webs 117. Alternatively, increasing the temperature of the cooling bath 144 may decrease the amount of contraction, which may decrease the depth of the grooves 113 and increase the thickness of the webs 117. In one example, the cooling bath may have a temperature of between about 50° F. and about 80° F. In other examples, the cooling bath may have any suitable temperature. Upon cooling, the extruded sheet 131 may be solidified with the surface features formed by the pattern roll.

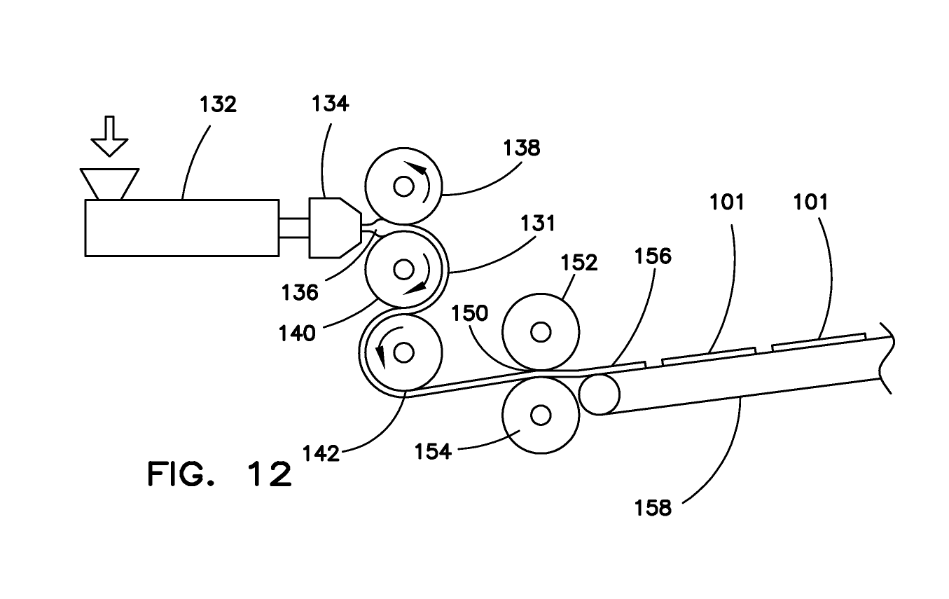

One or more film rolls 146 may supply a film 148 into the nip region 136 as shown in FIG. 11. The film 146 may be formed from a plastic material having a higher melting point than the plastic material of the extruded sheet 131. In this manner, the film 148 may remain dimensionally stable as it passes through the nip region 136 in direct contact with the plastic material forming the extruded sheet 131. The film roll 146 may have any width so that the film 148 may be aligned with any selected portion of the extruded sheet 131 or even extend over the entire width of the extruded sheet 131. Although the film 148 is shown to be entering the nip region 136 from below the die 134, it will be appreciated that the film may be introduced from above the die. The film 148 may be configured as a colored or patterned film that imparts a color, hue, tint, pattern, design or other effect to at least a portion of the extruded sheet 131. For example, the film may include a wood grain pattern such that the extruded sheet 131 may resemble a plurality of wooden planks attached to one another. The film 148 may be integrally bonded to a surface of the extruded sheet 131 so that the film and the extruded sheet cooperatively form a single structure exiting from the take off roll 142.

The extruded sheet 131, once cooled, may be cut into plastic sheets 101 of suitable dimension as shown, for example, in FIG. 1 to form a floor mat 100. In one example, the extruded sheet 131 may be cut by passing the extruded sheet between the nip 150 between two die cutting rolls 152 and 154 as shown in FIG. 12. As the die cut sheet 156 exits the nip 150, the individual plastic sheets 101 may be separated from one other by a conveyor 158 moving at a slightly higher speed than the exiting cut sheet 156. The pattern provided on the two die cutting rolls 152 and 154 may be varied as desired to provide the necessary perimeter dimensions for the plastic sheets 101. In other examples any suitable cutting element known in the art may be used instead of or in addition to the die cutting rolls 152 and 154.

While these features have been disclosed in connection with the illustrated preferred embodiment, other embodiments of the invention will be apparent to those skilled in the art and come within the spirit of the invention as defined in the following claims.

1. A one-piece, unitary floor mat comprising:
a continuous plastic sheet comprising an upper surface, a lower surface, and an outer perimeter that joins the upper surface and the lower surface;
a plurality of grooves disposed along the upper surface, each of the plurality of grooves comprising two sloped surfaces joined to one another at a trough in a substantially V-shaped configuration;
a plurality of channels disposed along the lower surface, each channel being substantially aligned with a single corresponding groove, and each groove being substantially aligned with a single corresponding channel; and
a plurality of substantially planar elongate panels defined by the grooves and the channels, an upper surface of each panel defined by two adjacent grooves and a lower surface of each panel defined by two adjacent channels.

2. The floor mat of claim 1, wherein the plurality of grooves and the plurality of channels are parallel to one another.

3. The floor mat of claim 1, further comprising a plurality of webs, each web disposed between one of the plurality of channels and a corresponding one of the plurality of grooves.

4. The floor mat of claim 3, wherein each web comprises a thickness of between about 0.02 inches and about 0.035 inches.

5. The floor mat of claim 1, wherein each panel comprises a thickness of between about 0.09 inches and about 0.105 inches.

6. The floor mat of claim 1, wherein each panel comprises a width of between about 1 inch and about 3 inches.

7. The floor mat of claim 1, wherein the widths of the plurality of panels are substantially equal to one another.

8. The floor mat of claim 1, wherein each channel comprises a depth of between about 0.06 inches and about 0.08 inches.

9. The floor mat of claim 1, wherein each channel comprises a width of between about 0.04 inches and about 0.06 inches.

10. A one-piece, unitary floor mat comprising:
a continuous plastic sheet comprising an upper surface, a lower surface, and an outer perimeter that joins the upper surface and the lower surface;
a plurality of grooves in the upper surface;
a plurality of channels in the lower surface, each channel positioned substantially opposite a single corresponding groove, and each groove positioned substantially opposite a single corresponding channel;
a plurality of flexible segments cooperatively formed by the grooves and the channels, each flexible segment disposed between one of the plurality of grooves and a corresponding one of the plurality of channels and comprising a thickness of between about 0.02 inches and about 0.035 inches; and
a plurality of substantially planar elongate panels defined by the flexible segments, each panel comprising a width of between about 1 inch and about 3 inches;
wherein each flexible segment is deformable in a first direction to move the lower surfaces of two adjacent panels angularly closer to one another and deformable in a second direction to move the upper surfaces of two adjacent panels angularly closer to one another.

11. The floor mat of claim 10, wherein successive panels are movable relative one another to roll the floor mat into a rolled configuration in which the lower surface of one panel is adjacent to the upper surface of another panel.

12. The floor mat of claim 10, wherein each of the plurality of grooves comprises two sloped surfaces joined to one another at a trough in a substantially V-shaped configuration.

13. The floor mat of claim 10, further comprising a secondary surface covering applied to the upper surface of the unitary, one-piece floor mat.

14. The floor mat of claim 10, wherein each channel comprises a depth of between about 0.06 inches and about 0.08 inches.

15. A method of forming a floor mat, the method comprising:
extruding a plastic material into a nip region between a pair of rolls, the pair of rolls comprising at least one pattern roll comprising a plurality of projections protruding radially outward from an outer surface of the pattern roll, the plurality of projections extending longitudinally along the pattern roll and being substantially parallel to one another;
extracting from the pair of rolls an extruded sheet comprising a plurality of channels formed in a lower surface of the extruded sheet, the plurality of channels reflective of the projections of the pattern roll;
passing the extruded sheet through a cooling unit; and
cutting the floor mat from the extruded sheet.

16. The method of claim 15, wherein, upon passing the extruded sheet through the cooling unit, a plurality of grooves is formed in an upper surface of the extruded sheet, and each groove is disposed opposite a corresponding channel.

17. The method of claim 16, wherein the pair of rolls comprises the pattern roll and a second roll, and the second roll is free of surface features corresponding to the grooves formed in the upper surface of the extruded sheet.

18. The method of claim 16, wherein a web is formed between each groove and the corresponding channel, and the web comprises a thickness of between about 0.02 inches and about 0.035 inches.

19. The method of claim 18, further comprising selecting a temperature of the cooling unit to control the thickness of the web.

20. The method of claim 15, wherein the projections are spaced from one another circumferentially about the pattern roll, and each projection is spaced from an adjacent projection by a distance of between about 1 inch and about 3 inches.
